(19) United States
(12) Patent Application Publication
(10) Pub. No.: US 2008/0169067 A1
(43) Pub. Date: Jul. 17, 2008

(54) Fixing device for a decorative plate of the top rail of a blind

(75) Inventor: De-Jun Zhang, Changping Town (CN)

Correspondence Address: BRUCE H. TROXELL, SUITE 1404, 5205 LEESBURG PIKE, FALLS CHURCH, VA, 22041, US

(73) Assignee: NIEN MADE ENTERPRISE CO. , LTD.

(21) Appl. No.: 11/654,033

(22) Filed: Jan. 17, 2007

(51) Int. Cl. E06B 9/266

(52) U.S. Cl. 160/38

(57) ABSTRACT

A fixing device for a decorative plate of the top rail of a blind includes a hanging block and a fixing member. The hanging block has at least a clamp base which has a hanging member extending upwardly and then downwardly from the upper margin of the rear side of aforesaid clamp base, possible to releasably hang anywhere upon the free margin of the top rail of a blind. The clamp base has an opening in a front wall, and a chamber extends longitudinally behind the opening. At least a clamp member is formed within the chamber with one end extends from the edge of the aforesaid opening and the opposite end has a projecting portion to define a smaller neck-like aperture at interior of the chamber. The fixing member includes a bottom plate with one surface being releasably gripped into the hanging block and the other surface being secured to the decorative plate, and a generally horizontal tenon with an end head formed sidewise at position respectively to the clamp member projecting forwardly from the bottom plate. Either the end head or clamp member holds a degree of resilient flexibility so that the foresaid end head may be inserted through the neck-like aperture, which allows the fixing member to be releasably gripped into the hanging block.

### BACKGROUND OF THE INVENTION

1. Field of the Invention

This invention relates to a blind, particularly to one provided with a fixing device for a decorative plate of the top rail of a blind.

2. Description of the Prior Art

A conventional venetian blind typically has a top rail for suspending a plurality of slats, and a decorative plate is given to coordinate with the materials and colors of the slats of the blind, and conceal the front wall of the top rail of which at the same time provides a blind with aesthetic appeal. And a fixing device is needed for the decorative plate to be lockly fixed to the top rail.

Examples of such fixing devices are disclosed in U.S. Pat. Nos. 4,384,605 and 6,672,359, both illustrated the similar construction in the field of fixing device for the top rail of a blind. The '605 patent teaches, as illustrated in FIGS. 1 and 2, including the fixing device 20 in which comprises a channel-shaped headrail 10 which has respectively spaced front and rear walls extending upwardly from opposite edges of a horizontally oriented bottom wall, and a U-shaped clip 21 and a strip holder 22. The said clip 21 is made of a plate 211 provided with a bight 212 extending rearwardly then downwardly from the upper edge of the plate 211 to facilitate engagement of aforesaid fixing device 20. The plate 211 is provided with a projecting flange 213 with a traversely extending, upwardly projecting ridge 214 at the end, and a pair of horizontally spaced, frontwardly projecting abutments 215 are provided at the lower end of the outer surface of the plate 211. The strip holder 22 is provided with a rearwardly opening groove 221 at interior upper surface of the plate 211, allowing the projecting flange 213 to releasably secured into the groove 221. A projection 222 extends rearwardly at interior lower surface of said strip holder 21 positioned to be received between said abutments 215, so said clip 21 is snugly secured into a desired location. The strip holder 22 has plural projecting hook elements 223, 224, 225 which disposed at respectively equal intervals near or along the top, intermediate and bottom exterior surface thereon, and a recess 226 formed behind the intermediate hook element 224, so that two decorative plates 23 may be respectively gripped and retained between said hook element 223 and said intermediate recess 226 and between the said intermediate hook element 224 and said bottom hook element 224, concealing the top rail 10 and further enhancing the aesthetic appeal of a blind.

Morris, U.S. Pat. No. 6,672,359 teaches a bracket for mounting a valance to a top rail includes a slide, an intermediate member and a second slide. The intermediate member is provided with a sidewise L-shaped tongue, and the second slide has two upwardly extending side walls which extend inwardly from the upper portion of the base of said second slide to define the tabs for one end of the intermediate member to securely fix therein, and the intermediate member provided with a tongue for releasably securing the fixing device. The slide has a funnel-shaped opening consists of the upper portions of the side walls angling outward for the other end of the intermediate member to insert therein. A connector in the form of cam extending forwardly from the exterior face of the slide with respect position to the groove on the decorative plate so as to secure the slide on the said decorative plate, hiding the top rail and further augmenting the decent appearance of the blind.

The fixing device 20 disclosed in the U.S. Pat. No. 4,384,605 can hide the top rail 10 with the decorative plate 23, but the plural hook elements 223, 224 and 225 are visibly exposed out, not able to completely achieve the concealing effect, and the two decorative plates 23 are separately inserted between the hook elements 223, 224 and 225 and the recess 226, and such fixing device utilizes plural projecting flanges 213 on the U-shaped clips 21 to securely grip into the opening groove 221 with the abutments 215 at lower end to limit the traverse movement of the projection 222. Thus, such invention only provides securing effect at upper portion, and not easy to engage with or disengage from the top rail.

Likewise, in U.S. Pat. No. 6,672,359 to Morris, though it does not have the drawback of exposing the hook elements 223, 224 and 225 such as in the '605 patent, the invention employs the connector in the form of cam extending forwardly from the exterior face of the slide to secure the decorative plate, which not possible to fully limit the lateral movement of the decorative plate wherein a respectively longitudinal groove have to be constructed, this will increase the production expenses and complicate the assembly process and further create the inconvenience while engaging with or disengaging from the top rail. Both of the inventions known to exhibit a degree of disadvantage, which are desirable to be mitigated and improved to exempt from the problems caused.

### SUMMARY OF THE INVENTION

This invention is directed to a blind fixing device for holding the decorative plate upon the top rail of a blind, a least two of such fixing devices are installed on the front face of the top rail to securely hold the decorative plate in position. The fixing device includes a hanging block and a fixing member. The hanging block has at least a clamp base, and a hanging member extending backwardly and then downwardly from the upper margin of a rear wall of the clamp base for hanging anywhere on the top rail. The clamp base is provided with an opening in a front wall, and a lengthwise chamber formed extending behind the opening, and at least a clamp member is constructed with one end extending from the edge of the opening into the chamber and the other end formed with partially projecting portion so as to define a smaller neck-like aperture therein. The fixing member has a bottom plate, which has one side releasably gripped upon the hanging block and the other side being securely mounting to a decorative plate. A projecting tenon with sidewise end head is formed sitting in correspondence position to the clamp member. Either the end head or clamp member has a degree of resilient flexibility to allow the end head passing through the neck-like aperture.

This invention particularly aims at providing blind fixing device for the decorate plate which is attached with plural of fixing members, and either the end head or clamp member has a degree of resilient flexibility allowing the end head to pass through the neck-like aperture so as to hold the tenon snugly pinched in place and the fixing member is closely secured with the hanging block. It is therefore an object of this invention to provide a versatile yet simple constructed fixing device for easy assembly, and one side of the decorative plate is securely mounted to the fixing member so as to fully conceal the top rail and add aesthetic appeal to a blind. Yet a further aspect of the present invention provides an easy arrangement on disassembly by disengaging the tenon away from the neck-like aperture. It should also be appreciated that the fixing device of this invention solves all of the problems otherwise associated with the assembly and disengagement difficulty comparatively to both U.S. Pat. Nos. 4,384,605 and 6,672,359.

Other objects, features and advantages of this invention will be apparent from a consideration of the detailed description given below in conjunction with the accompanying drawings.

### BRIEF DESCRIPTION OF DRAWINGS

This invention will be better understood by referring to the accompanying drawings, wherein:

FIG. 1 is an exploded end view of a fixing device for the decorative plate of the top rail of a blind in the U.S. Pat. No. 4,384,605;

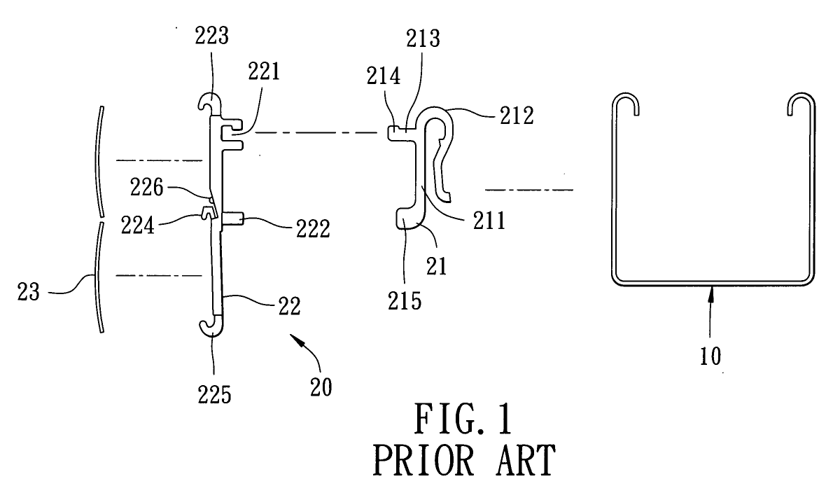

FIG. 2 is a perspective view of the fixing device in the U.S. Pat. No. 4,384,605;

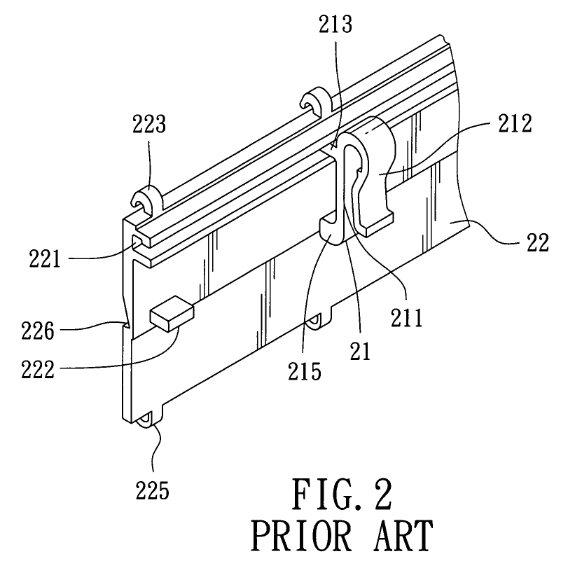

FIG. 3 is an exploded view of one embodiment of a fixing device of the present invention in which no assembly has yet taken place;

FIG. 4 is an exploded view of the embodiment of a fixing device illustrated in FIG. 1 in which two mounting screws, a top rail and a decorative plate are shown at correspondence assembly position;

FIG. 5 is a perspective view of the embodiment of the fixing device illustrated in FIG. 4 in which the components of the fixing device have been assembled and secured to a top rail and a decorative plate shown mounting to the front wall of the top rail;

FIG. 6 is a fragmentary traverse view of the fixing device illustrated in FIG. 5;

FIG. 7 is a perspective view, similar to FIG. 3, showing an alternative embodiment of the fixing device of the present invention depicting the modified arrangement on tenon and chamber;

FIG. 8 is an perspective view of a further alternative embodiment of the present invention;

FIG. 9 is a perspective view of still another embodiment of the present invention; and

FIG. 10 is a fragmentary schematic partial front view illustrating the fixing member assembled with the decorative plate.

### DETAILED DESCRIPTION OF THE PREFERRED EMBODIMENTS

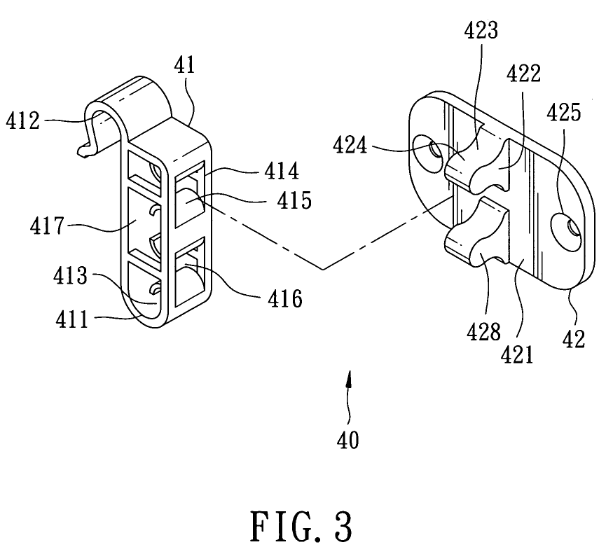

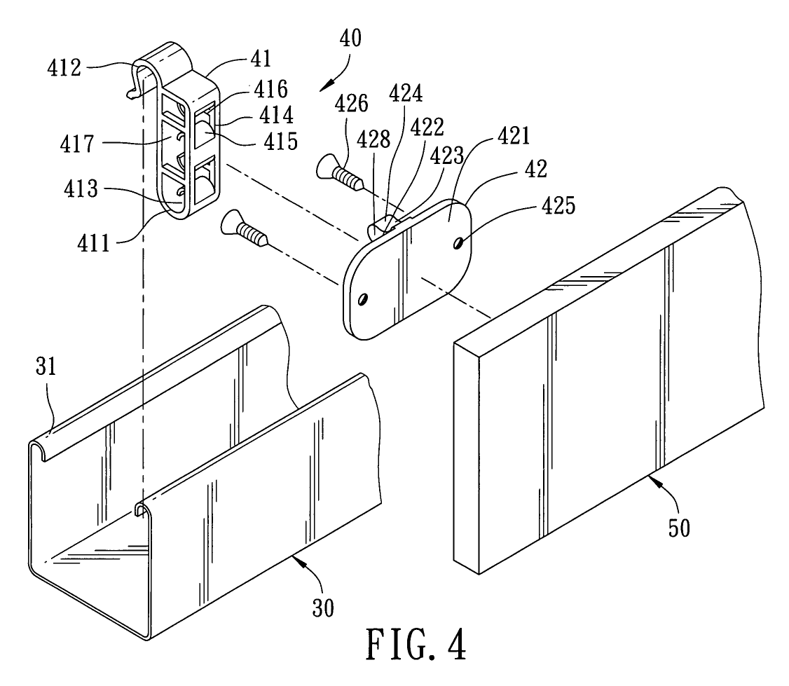

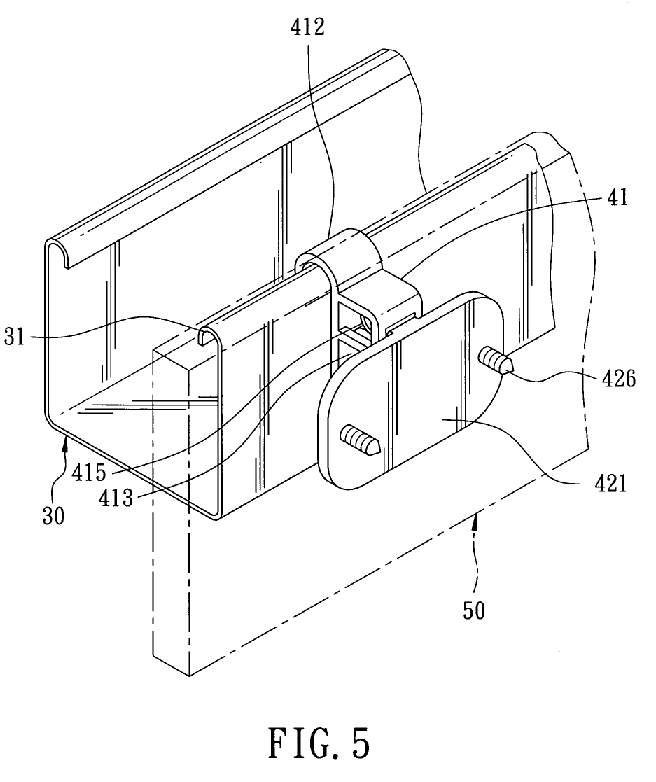

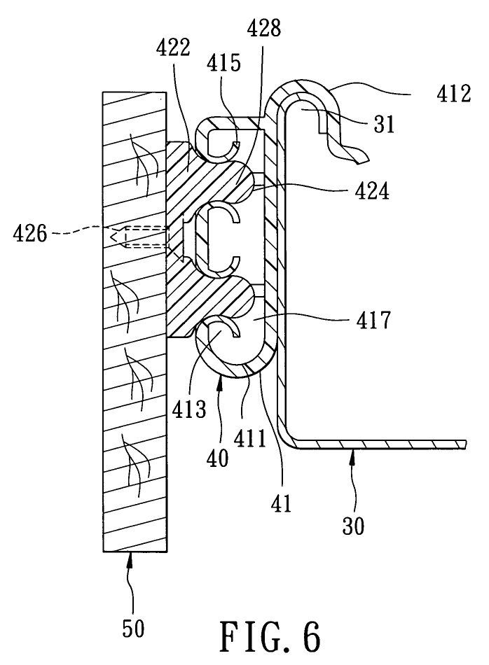

According to the present invention, a first embodiment of a blind fixing device for the decorative plate of the top rail, as shown in FIGS. 3-6, is to be hung on the top rail 30 of a blind, which is U-shaped, having two flat, generally vertically oriented side walls and a substantially horizontal bottom base, a bowing upper margin 31 formed bent inwardly then downwardly at an upper margin of two side walls. At least two fixing devices 40 attached to a front wall of the top rail 30 for securely hanging a decorative plate 50 and further concealing the top rail 30, which comprises a hanging block 41 and a fixing member 42 together to be secured upon the top rail 30 of a blind.

The hanging block 41 is provided with two clamp bases 411 formed longitudinally, a projecting hanging member 412 extending backwardly and then downwardly from an upper margin of a rear wall of each clamp base 411, and the projecting hanging member 412 holds a degree of resilient flexibility, able to hang against upon the bowing upper margin 31 of the top rail 30. The projecting hanging member 412 allows the hanging block 41 to adjustably slide alongside the front wall of the top rail 30. Further the clamp bases 411 are respectively provided with two openings 414 in a front surface, and a longitudinal chamber 413 is formed behind each opening 414, having proper dimensions and defined by surrounding walls. Two traversely extending clamp members are disposed at relatively upper and lower positions with proper interval within each chamber. A lower curved clamp member 415 extends inwardly and then downwardly from the lower margin of the opening 414, with its length matching with the width of the clamp base 411 and having a free end formed within the chamber 413. And an upper curved clamp member 415 extends inwardly and then upwardly from the upper margin of the opening with its length matching with the width of the clamp base 411 and having a free end within the chamber 413. As known both the lower and upper clamp members 415 respectively extend in opposite direction to form the partially-curved portion at one end and have free end on the other side so as to create a degree of resilient flexibility and further define a smaller neck-like aperture 416 at the interior of the chamber 413, and a larger chamber 417 is formed behind the chamber 413.

The fixing member 42 is used for securing the decorative plate 50 with the hanging block 41, provided with a bottom plate 421, which has a front surface to be combined tightly with the hanging block 41 and a rear surface to be fixed with the decorative plate 50. Then two sidewise tenons with nominal thickness 422 are formed and spaced apart on a front surface of the bottom plate 421 at correspondence positions to the respective neck-like apertures 416 between both clamp members 415. It has been found that each tenon has coordinating upper and lower curving surfaces 423 in respective position to two clamp members 415, relatively big portion of an end head 428 to protrude into the larger chamber 417 of the hanging block 41, and the upper curved surface 423 and the lower curved surface 423 of the end head 428 smoothly connected to form a rounding angle 424, facilitating the tenon 422 to slide through the opening 414 and into the chamber 413 to be snugly pinched within the neck-like aperture 416. And the resilient flexibility of the clamp members 415 allows both tenons 422 to be releasably pinched by the interfitting and cooperation effect between the clamp members 415 and the end heads 428 which allows the fixing member 42 to be lockly engaged to the hanging block 41. Then the fixing member 42 is further provided with a ball-shaped through hole 425 respectively in two sides through which a screw 426 is passed for securely mounting the fixing member 42 to the rear surface of the decorative plate.

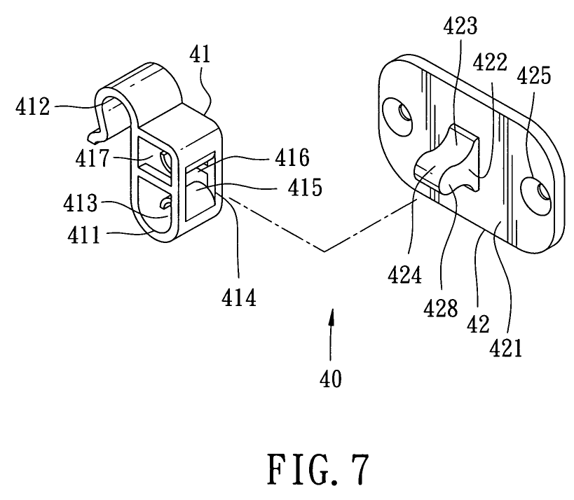

FIG. 7 shows an alternative embodiment of a fixing device according to the present invention. It has the similar structure as of that illustrated in FIG. 3. The fixing device 40 consists of a hanging block 41 and a fixing member 42, and the hanging block 41 has only one clamp base 411, a projecting hanging member 412 extending rearwardly and then downwardly from an upper margin of a rear wall of the clamp base 411 to define a partially-curved portion there along. The projecting hanging member 412 holds a degree of resilient flexibility, possible to securely attached upon the upper margin 31 of the front wall of the top rail 30 and allowing the hanging member 412 to bring hanging block adjustably slide alongside the front wall of the top rail 30. The clamp base 411 is provided with an opening 414 in a front wall, and a chamber 413 of a desirable dimension formed behind the opening 414 and defined by surrounding walls therein. A pair of clamp members 415 is formed extending inwardly from the respective edge of the opening 414, disposed at desired interval at respective upper and lower interior of the chamber 413. A lower curved clamp member 415 extends inwardly and then downwardly from the lower margin of the opening 414, with its length matching with the width of the clamp base 411 and having a free end formed within the chamber 413. And an upper curved clamp member 415 extends inwardly and then upwardly from the upper margin of the opening with its length matching with the width of the clamp base 411 and having a free end within the chamber 413. As known both the lower and upper clamp members 415 respectively extend in opposite direction to form the partially-curved portion at one end and have free end on the other side so as to create a degree of resilient flexibility and further define a smaller neck-like aperture 416 at the interior of the chamber 413, and a larger chamber 417 is formed behind the chamber 413. The fixing member 42 has a bottom plate 421, which has a rear surface to be securely mounted with the decorative plate 50 and a front surface to be snugly gripped into the hanging block 41. A substantially projecting sidewise tenon 422 with respective position to the neck-like aperture 416 between both clamp members 415 is formed on the front surface of the bottom plate 421. Such tenon has coordinating upper and lower curving surfaces 423 in respective position to two clamp members 415, relatively big portion of an end head 428 to protrude into the larger chamber 417 of the hanging block 41, and the upper curved surface 423 and the lower curved surface 423 of the end head 428 smoothly connected to form a rounding angle 424, facilitating the tenon 422 to slide through the opening 414 and into the chamber 413 to be snugly pinched within the neck-like aperture 416. And the resilient flexibility of the clamp members 415 allows both tenons 422 to be releasably pinched by the interfitting and cooperation effect between the clamp members 415 and the end heads 428 which allows the fixing member 42 to be lockly engaged to the hanging block 41.

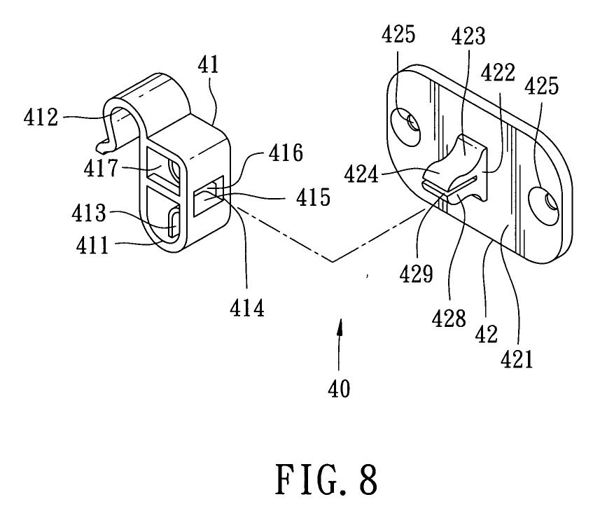

As can be seen in FIG. 8, it shows a further embodiment of the present invention, which also includes a hanging block 41 and a fixing member 42. The hanging block 41 is provided with a clamp base 411, and a projecting hanging member 412 holds a degree of resilient flexibility and extending backwardly and then downwardly from an upper margin of a rear wall of the clamp base 411. The projecting hanging member 412 snugly hangs on the curved upper margin 31 of the front wall of the top rail 30 of a blind, allowing the hanging block 41 slide along the front wall of the top rail. The clamp base 411 is provided with an opening 414 in a front wall and a chamber 413 formed behind the opening 414 defined by surrounding walls, A pair of clamp members 415 is formed extending inwardly from the respective edge of the opening 414, disposing at desired interval at respective upper and lower interior of the chamber 413. One of the curved clamp members 415 extends inwardly and then downwardly from the lower margin of the opening 414, having a free end formed within the chamber 413. And the other curved clamp member 415 extends inwardly and then upwardly from the upper margin of the opening, having a fixed end within the chamber 413. Thus, a smaller neck-like aperture is formed at interior of the chamber 413. The fixing member 42 has a bottom plate 421, which has a front surface combined tightly with the hanging block 41 and a rear surface mounted to a decorative plate 50 by screws. The bottom plate 421 is provided with a tenon 422 extending sidewise from an intermediate portion to face the opening 414 and the neck-like aperture 416 of the hanging block 41. The tenon 422 has a curved upper surface 423 and a curved lower surface 423 to match with the two curved clamp members 415, and a relatively big portion of an end head 428 defined by the upper and the lower curved surfaces 423, to protrude into a larger chamber 417 formed behind the chamber 413. Then the upper and the lower curved surface 423 and 423 form a rounding angle 424 for the tenon 422 to easily slide through and releasably pinched into the neck-like aperture 416. In addition, the tenon 422 has a traversely, gap-cutting cross section 429 along the horizontal axis extending from the frontmost end, which gives the end head 428 of the tenon 422 a degree of deforming flexibility so that the tenon 422 may be pinched in the neck-like aperture 416 stably. While the end head 428 is deformed at a degree while entering such neck-like aperture, it may eventually rebound afterwards to securely sit against the two clamp members 415. Such resilient flexibility allows both tenons 422 to be releasably pinched by the interfitting and cooperation effect between the clamp members 415 and the end heads 428 which allows the fixing member 42 to be lockly engaged to the hanging block 41.

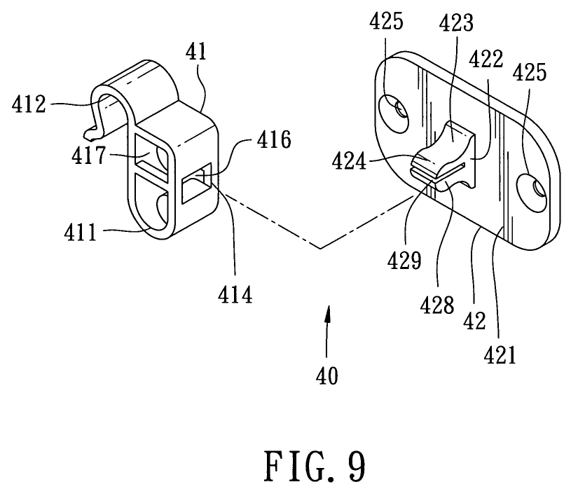

FIG. 9 illustrates another possible embodiment of a fixing device according to the present invention. It also includes a hanging block 41 and a fixing member 42. The hanging block 41 is provided with a clamp base 411 and a projecting hanging member 412 extending backwardly and then downwardly from an upper margin of a rear wall of the clamp base 411 and hanging on the curved upper margin 31 of the top rail 30 of a blind. Then the hanging member 412 can allow the hanging block 41 slide on the front wall of the top rail 30. The clamp base 411 is provided with an opening 414 in a front wall and a chamber 413 of a desired dimension formed behind the opening 414 and defined by surrounding walls. The upper wall and a lower wall at interior of the chamber 413 are provided with a solid projection to define a smaller neck-like aperture 416. The fixing member 42 has a bottom plate 421, which has a front surface combined tightly with the hanging block 41 and a rear surface mounted to a decorative plate 50 by screws. The bottom plate 421 is provided with a tenon 422 extending sidewise from an intermediate portion to face the opening 414 and the neck-like aperture 416 of the hanging block 41. The tenon 422 has a curved upper surface 423 and a curved lower surface 423 to match with the two curved clamp members 415, and a relatively big portion of an end head 428 defined by the upper and the lower curved surfaces 423, to protrude into a larger chamber 417 formed behind the chamber 413. Then the upper and the lower curved surfaces 423 and 423 form a rounding angle 424 for the tenon 422 to easily slide through then subsequently releasably pinched into the neck-like aperture 416. In addition, the tenon 422 has a traversely, gap-cutting cross section 429 along the horizontal axis extending from the frontmost end, which gives the end head 428 of the tenon 422 a degree of deforming flexibility so that the tenon 422 may be pinched in the neck-like aperture 416 stably. While the end head 428 is deformed at a degree while entering such neck-like aperture, it may eventually rebound afterwards to securely sit against the two clamp members 415. Such resilient flexibility allows both tenons 422 to be releasably pinched by the interfitting and cooperation effect between the clamp members 415 and the end heads 428 which allows the fixing member 42 to be lockly engaged to the hanging block 41.

It is worth to mention that. A projecting hanging member 412 is able to extend rearwardly and then downwardly from an upper margin of a rear wall of the clamp base 411 to form a resilient portion therealong. One end of such hanging member is attached to the interior of the rear wall of the top rail. Alternatively, the hanging member 412 can also be hung anywhere along the top rail 30.

Another point worth to note is that the traversely, gap-cutting cross section 429 formed in the tenon 422 can allow the tenon 422 to disfigure and maintain a degree of resilient flexibility. Moreover, the two respectively positioned clamp members 415 extend in opposite direction to create partially curving portions away from each other with one end extending inwardly from the edge of the opening 414 and the other end creates a free end within the chamber 413. Alternatively, both ends of two clamp members can be fixed to the sides of neck-like aperture to securely lock the tenon 422.

The fixing device for a decorative plate of a top rail of a blind according to the present invention is very convenient in assembling and disassembling. For assembling, more than two hanging blocks 41 are hung on the front wall of the top rail 30, and then the interior of a decorative plate 50 is mounted with the fixing members 42 by screws 426 passing through the through mounting holes 425 of the fixing members 42 and then screwed to the decorative plate 50. Then the fixing members 42 are combined with the hanging blocks 41 by inserting the tenon 422 into the opening 414 of the chamber 415 and then interfitted tightly with the neck-like aperture 416, with the two curved clamp members 415 partially deformed so that the decorative plate 50 is laterally attached on the top rail 30.

When the fixing device 40 is to be disassembled, the fixing members 42 are to be separated from the hanging block 41 by pulling the tenon 422 off away from the neck-like aperture 416, then the decorative plate 50 will be disengage from the hanging blocks 41, unscrewed from the fixing member 42 and free to be replaced.

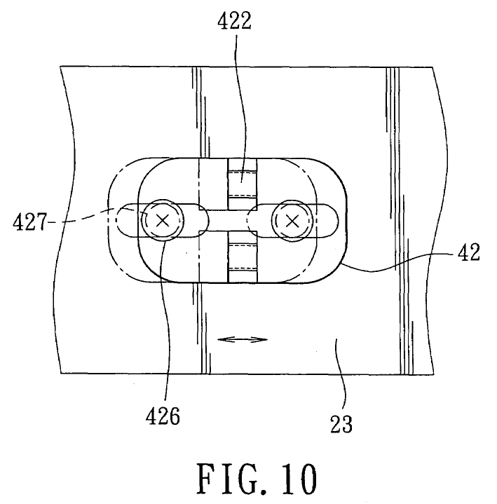

In addition, FIG. 10 shows another embodiment of the fixing member, which is provided with the longitudinal, oval-shaped through holes 427 extending in a horizontal axis instead of the ball-shaped through holes 425 illustrated in the other embodiments, allowing a degree of deviation movement from exact position while fixing member 42 is adjustably assembled to the decorative plate 50. While the mounting screws are already lockly tightened and the tenon 422 is sit partially deviating from the neck-like aperture 411, such fixing member 42 can still be adjustably moved at traverse direction relatively to the stationary mounting screws 426 to achieve the desired position without loosening the mounting screws 426.

In accordance with these and other objects which become apparent from the aforesaid description, and could be further summarized hereinafter:
1. Either the clamp members 415 or the tenons 422 hold a degree of resilient flexibility to effect the locking engagement so that the tenon 422 may be snugly gripped by the clamping effect resultantly from the clamp members 415 and end heads 428, allowing the fixing member 42 releasably secured to the hanging block 41. Such resilient flexibility may also ease the assembly insertion of tenons 422 and enhance the interfitting effect associated with the clamp members 415 and tenons 422.
2. The decorative plate 50 is mounted upon the top rail by means of the fixing member 42 engaged with the hanging block 41. To disassemble, simply disengage the tenon 422 of the fixing member 42 away from the hanging block 41. Such fixing device is particularly easy and convenient for assembly and disassembly arrangement.
3. The projecting hanging member 412 of the hanging block 41 can be made in varying designs so as to lockly secure the decorative plate 50 upon the top rail.
4. The number of the clamp base 411 can be altered and supplied with single or numerous neck-like apertures therein according to the practical use.
5. The fixing device is easy to manufacture with less expenses and parts associated are constructed in simple practical forms with versatility in appearance, making the decorative plate 50 fully conceal behind the top rail 30, augmenting the aesthetic of a blind.

It is intended that the foregoing description and showings made in the drawings shall be conceived only as an illustration of the principles of the instant invention, which is therefore not to be limited to the details disclosed herein, but it is to be acknowledged the full scope of the claims so as to embrace in the variety of forms by one skilled in the art.

What is claimed is:

1. A fixing device for a decorative plate of the top rail of a blind, said device comprising:
a hanging block provided with a clamp base, a projecting hanging member formed extending upwardly then downwardly from the upper margin of a rear wall of said clamp base, said hanging member possible to releasably hang anywhere upon the free margin of the top rail of a blind, said clamp base having an opening in a front wall thereof, a lengthwise chamber formed behind said opening, at least a clamp member formed extending inwardly from said opening and having a projecting portion therein so as to define a smaller neck-like aperture; and,
a fixing member provided with a bottom plate having one surface being snugly gripped with said hanging block and the other surface mounted to a decorative plate, said bottom plate has a front surface formed with an frontwardly projecting tenon sitting in correspondence position to said clamp member, said tenon having an end head defined by a relatively big dimension in size comparatively to the associated spacing defined by said neck-like aperture of said chamber, either said end head or said clamp member of said hanging block having a degree of resilient flexibility to let said end head pass through said neck-like aperture in said chamber of said hanging block, said neck-like aperture keeps said tenon releasably pinched in place so that said fixing member is snugly secured with said hanging block.

2. The fixing device for a decorative plate of the top rail of a blind as claimed in claim 1, wherein said projecting hanging member of said hanging block extends upwardly and then downwardly from an upper margin of said clamp base rear wall to form an inward return bight so as to hold a degree of resilient flexibility therein.

3. The fixing device for a decorative plate of the top rail of a blind as claimed in claim 1, wherein said hanging member of said hanging block adapted to hook upon the upper margin of the front wall of said top rail.

4. The fixing device for a decorative plate of the top rail of a blind as claimed in claim 1, wherein said chamber of said clamp base has two clamp members, which respectively have their free ends extended in opposite direction from each other to define partially arch-liked portions thereon.

5. The fixing device for a decorative plate of the top rail of a blind as claimed in claim 4, wherein said two clamp members extend inwardly within said chamber in respective position with one being at upper end of said opening and the other at lower end of said opening.

6. The fixing device for a decorative plate of the top rail of a blind as claimed in claim 1, wherein the frontmost end of said tenon is provided with a traversely, gap-cutting cross section.

7. The fixing device for a decorative plate of the top rail of a blind as claimed in claim 1, wherein the frontmost end of said tenon has a rounding angle defining said end head.

8. The fixing device for a decorative plate of the top rail of a blind as claimed in claim 1, wherein said hanging block is provided with two clamp bases disposing at upper and lower position relatively to each other, and said fixing member is provided with two tenons locating in a correspondence position to said two clamp bases.

9. The fixing device for a decorative plate of the top rail of a blind as claimed in claim 1, wherein said fixing member is provided with two through holes in opposite sides for screw-mounting purpose so as to allow the screws to pass through both holes and lockingly secure at rear surface of said decorative plate to said fixing member.

10. The fixing device for a decorative plate of the top rail of a blind as claimed in claim 9, wherein each of said through holes are longitudinally oval-shaped, and said oval-shaped through holes have a lengthwise axis defining an included angle to the horizontal surface.

11. A fixing device for a decorative plate of the top rail of a blind, said device comprising:
a hanging block provided with at least a clamp base, a hanging member extending upwardly and then downwardly from an upper margin of a rear wall of said clamp base, said hanging member allows said clamp base to releasably hang anywhere upon the free margin of the top rail of a blind, said clamp base provided with an opening in a front wall, a lengthwise chamber formed behind said opening and having a smaller neck-like aperture at interior of said chamber; and,
a fixing member provided with a bottom plate having one surface being snugly gripped with said hanging block and the other surface mounted to a decorative plate, said bottom plate has a front surface formed with a frontwardly projecting tenon sitting in correspondence position to said neck-like aperture, said tenon having an end head defined by a relatively big dimension in size comparatively to the associated spacing defined by said neck-like aperture of said chamber, the front end of said tenon is provided with a traversely, gap-cutting cross section so as to hold a degree of resilient flexibility thereof, when said end head is disposed at interior of said chamber, said neck-like aperture keeps said tenon releasably pinched in place so that said fixing member is snugly secured with said hanging block.

12. The fixing device for a decorative plate of the top rail of a blind as claimed in claim 11, wherein said projecting hanging member of said hanging block extends upwardly and then downwardly from an upper margin of said clamp base rear wall to form an inward return bight so as to hold a degree of resilient flexibility therein.

13. The fixing device for a decorative plate of the top rail of a blind as claimed in claim 11, wherein said hanging member of said hanging block adapted to hook on the upper margin of the front wall of said top rail.

14. The fixing device for a decorative plate of the top rail of a blind as claimed in claim 11, wherein said hanging block is provided with two clamp bases disposing at upper and lower position relatively to each other, and said fixing member is provided with two tenons locating in a correspondence position to said two clamp bases.

15. The fixing device for a decorative plate of the top rail of a blind as claimed in claim 11, wherein said fixing member is provided with two through holes in opposite sides for screw-mounting purpose so as to allow the screws to pass through both holes and lockingly secure said decorative plate to said fixing member.

16. The fixing device for a decorative plate of the top rail of a blind as claimed in claim 15, wherein each of said through holes are longitudinally oval-shaped, and each of said oval-shaped through hole have a lengthwise axis defining an included angle to the horizontal surface therebetween.
